(19) United States
(12) Patent Application Publication
(10) Pub. No.: US 2017/0039899 A1
(43) Pub. Date: Feb. 9, 2017

(54) PORTABLE SIGN SYSTEM

(71) Applicant: Patricia Manos, McKinney, TX (US)

(72) Inventor: Patricia Manos, McKinney, TX (US)

(21) Appl. No.: 14/817,349

(22) Filed: Aug. 4, 2015

(51) Int. Cl. G09F 7/18

(52) U.S. Cl. CPC G09F 7/18; G09F 2007/1804; G09F 2007/1834; G09F 2007/1843

(57) ABSTRACT

A portable sign system suitable for advertising signs removably inserted into the earth, such as real estate signs, has a display frame for holding a sign placard, frame sides, and separate ground stakes. Each of the ground stakes can be releaseably connected to one of the frame sides or bottom frame in one of two positions. In the first position, the ground stake is extended from the respective frame side so that the ground stake can be inserted into the ground; in the second position, the orientation of the ground stake is reversed when connected to the frame side or is laid parallel to the bottom frame, so that the overall length of the portable sign system is reduced from that of the first position. The reduction in length allows the portable sign to be easily loaded into the trunk of a vehicle, for example.

### BACKGROUND

Technical Field

This disclosure relates to a system and apparatus for a display sign, in particular, portable display signs for temporary location in a yard or field.

Background

In recent years in the United States, the marketing and sale of homes and other single family dwellings has become increasingly competitive. As a result, the way real estate is advertised has become increasingly important. An important part of the advertising program is the use of real-estate signs planted in the front yards of residential homes, or open spaces pertaining to commercial property, to alert the public to the availability of that property. It is therefore important that such signs be quickly and easily installed once a property is listed for sale, and that such signs similarly be quickly and easily removed when the time for advertising or sales promotion has ended.

Real-estate brokerage firms often hire an independent contractor to erect and take down such signs. Use of an independent contractor increases the expense and delays the installation and removal of the sign until the order for installation or removal can be processed and scheduled. In many brokerage businesses, therefore, the individual real-estate agent handling the listing is expected to carry, install, and remove the sign at the sales location. Such signs typically have a metal frame forming the shape of a flat plate, from which stakes protrude toward the ground. These sign structures are installed by the agent using his or her body weight to drive the stakes into the ground. Usually two or more ground support legs are used in this type of sign support. A persistent problem in the installation of such signs is that the sign structure is too large to fit into a normal passenger vehicle trunk, and generally agents will be driving normal passenger vehicles. If the sign is loaded sideways into the back seat of a vehicle, there is a risk of tearing upholstery and dispersing dirt from the ground into the vehicle. Besides the inconvenience of loading the sign into the back seat of a vehicle, such damage and dirt detracts from the professional appearance the agent wishes to convey to clients.

What is needed is a sign frame that conveys a permanent professional image when installed on site, but which at the same time can be readily disassembled into prefabricated component parts for carrying by hand, transporting in a normal passenger car, and storage.

### SUMMARY

A portable sign system suitable for advertising signs removably inserted into the earth, such as real estate signs, has a display frame holding one or more sign placards, frame sides, and separate ground stakes. Each of the ground stakes can be releaseably connected to one of the frame sides, or bottom frame side, in one of two positions. In the first position, the ground stake is extended from the respective frame sides so that the ground stake can be inserted into the ground; in the second position, the orientation of the ground stake is reversed when connected to the frame side, or aligned with the bottom frame side, so that the overall length of the portable sign system is reduced from that of the first position. The reduction in length allows the portable sign to be easily loaded into the trunk of a vehicle, for example. The ground stakes are connected to the frame sides, or frame bottom, with one or more releaseable connectors, such as bolts engaging threaded receivers, or pins and slots. In another embodiment, the display frame has support legs extending therefrom, and the ground stakes are connected to the support legs.

### DRAWINGS

FIG. 1 shows an embodiment of the portable sign system with its component parts shown separately.

FIG. 2 shows an embodiment of the portable sign system with its component parts connected in a first position for inserting the ground stakes into the ground.

FIG. 3 shows an embodiment of the portable sign system with its component parts connected in a second position for transport and storage of the sign.

FIG. 4 shows a further embodiment of the portable sign system with its component parts connected in a second position for transport and storage of the sign, in this case, by the folding of the ground stakes against the bottom frame of the sign and fastening them to the bottom frame.

FIG. 5 is an enlarged view of an embodiment of the connections to the sign frame made by the ground stakes of the foregoing embodiments.

FIG. 6 is an embodiment of the portable sign system with its component parts connected in a second position for transport and storage of the sign, in this case connection to the frame sides of the sign.

FIG. 7 shows a further embodiment of the portable sign system, where the sign frame has legs, with its component parts shown separately.

FIG. 8 shows the embodiment of FIG. 7, with the ground stakes connected to the legs of the sign frame.

FIG. 9 shows the embodiment of FIG. 7, with the ground stakes reversed and connected to the legs of the sign for transport and storage.

### DETAILED DESCRIPTION

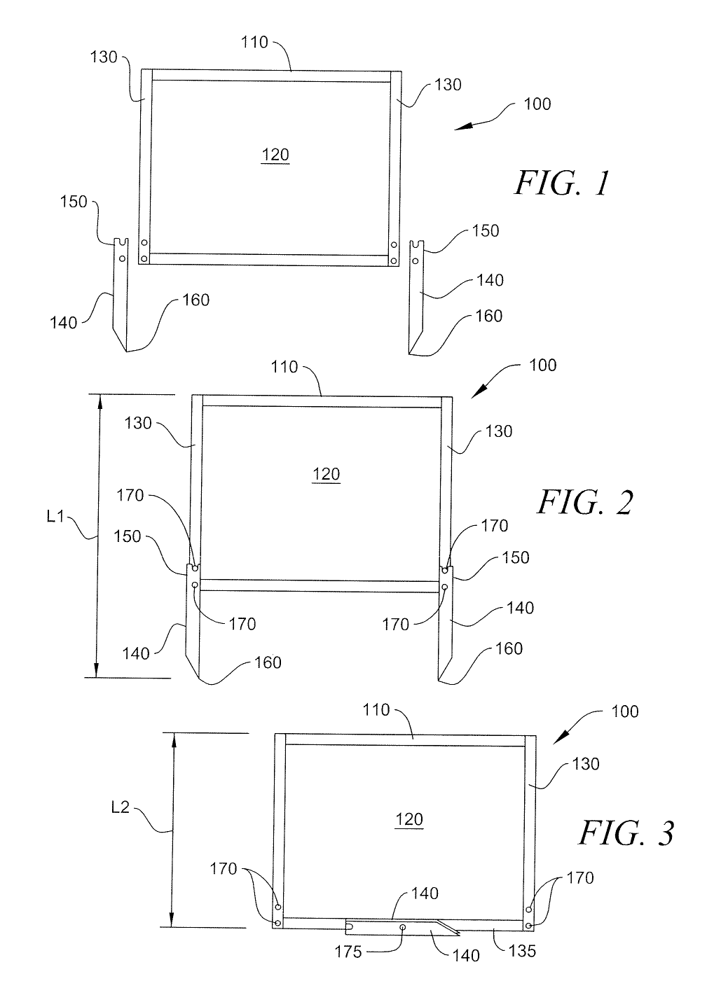

FIG. 1 shows an embodiment of the portable sign system 100. A display frame 110 component is capable of holding a typical flat display placard 120, such as a real-estate “For Sale” sign. The display frame 110 is preferably rectangular, but may if convenient or desired be formed in some other shape, such as a square, so long as the display frame 110 has substantially straight frame sides 130.

For all embodiments in this application “vertical” means the direction running top to bottom in the figure sheets, with top being “up” and the bottom being “down,” and would in practice be the direction in which the sign system 100 is mounted in the ground, such as a residential yard, so that it stands upright.

Associated with each frame side 130 is a ground stake 140. Each ground stake 140 has a first end 150 and a second end 160. The second end 160 of each ground stake 140 is preferably pointed for easier insertion into the ground, but need not be so made. Each ground stake 140 is capable of being attached to the frame side 130 in two different positions.

The display frame 110, including frame sides 130, and ground stakes 140 may be conveniently made of steel in the structural shape known as “angle iron.” Other material, or with a different cross-sectional shape, could also be used, so long as it is rigid and strong enough to resist the forces applied to it.

FIG. 2 shows the ground stakes 140 releaseably connected to the frame sides 130 in a first position where the second end 160 of each ground stake 140 is directed downwardly for insertion into the ground, and the first end 150 of the ground stake 140 is directed upward. The overall length of the sign 100 is called “L1” in FIG. 2.

Each ground stake 140 is releaseably connected to the frame side 130 at one or more connectors 170, as shown in the figures. The connectors 170 need only be strong enough to hold the frame sides 130 and ground stakes 140 together during insertion into the ground, and thereafter against wind forces or accidental bumps, and preferably are types easily undone and re-done. The connectors 170 can be, for example, bolts, screws, pins in holes or slotted openings, or pin-and-detent devices, all as are known in the art relating to connectors. Bolts or screws, such as thumbscrews, may engage threaded receivers in the frame sides 130. Details of one embodiment of such fastening are shown in FIG. 5, discussed below.

In the configuration shown in FIG. 2, the portable sign system 100 may be easily inserted into position, by forcing the ground stakes 140 into the ground, such as a residential yard, by applying pressure to the top of the display frame 110. When so inserted into the ground, the portable sign system 100 will be as sturdy as a cumbersome conventional sign frame.

FIG. 3 shows an embodiment of the fastening of the ground stakes 140 to the frame 110 of the portable sign 100. In FIG. 3, the ground stakes 140, when disconnected from the frame sides 130, are placed against the bottom frame side 135 of the portable sign 100, and fastened thereto with one or more second connectors 175, which could be one or more bolts passing through a hole in the ground stakes 140 and thus fastening the ground stakes 140 to the bottom frame side 135. The overall length of the sign 100 is called “L2” in FIG. 3 L2 is less than L1 by a distance approximately equal to the lengths of the ground stakes 140, and so the sign 100 may be easily fitted into the trunk of an automobile. The length L2 can be easily estimated and provided for in the construction of the portable sign system 100 by consulting manufacturer's specifications for trunk dimensions of vehicles typically used by real-estate agents.

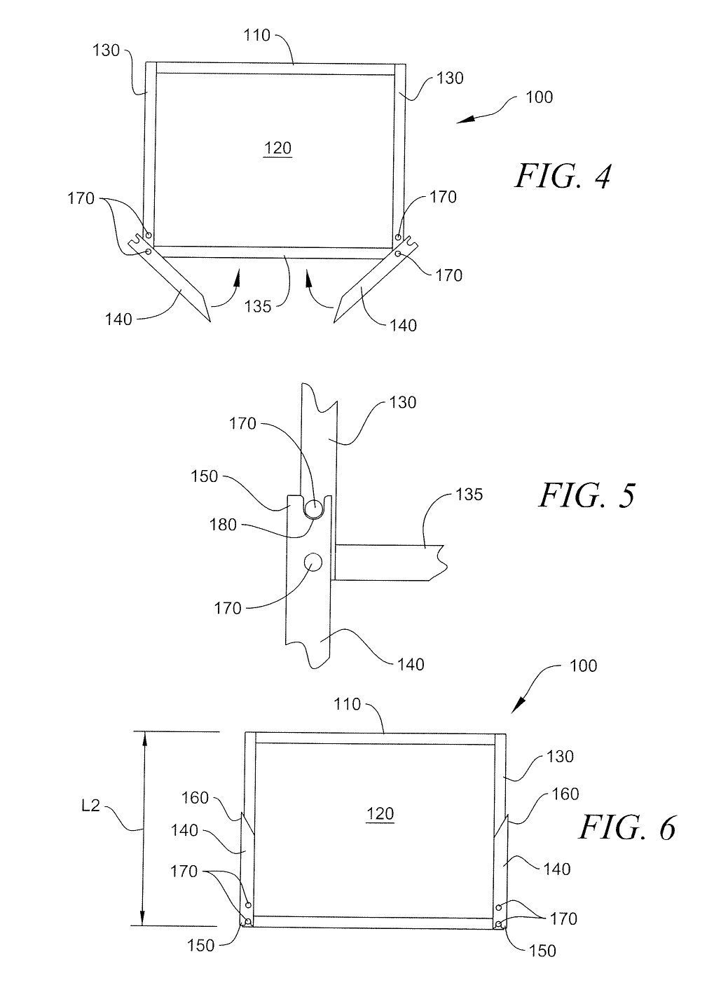

FIG. 4 is a further alternate embodiment of the fastening of the ground stakes 140 to the frame 110 of the portable sign 100. In FIG. 4, each of the ground stakes 140 rotate in a hinged fashion about one of the connectors 170 in the frame sides 130 to rest against the bottom frame side 135 of the portable sign 100. The ground stakes 140 may then be fastened into place against the bottom frame side 135 by a second connector 175 as shown in FIG. 3, or by tightening the connectors 170 in the frame sides 130. The same reduction in overall length of the portable sign 100 is achieved as shown in the previous drawings.

FIG. 5 shows an enlarged detail of an embodiment of the fastening of the ground stakes 140 to the side frame 130. In FIG. 5, the first end 150 of the ground stake 140 has a U-shaped cutout 180, so as to engage a pin or bolt connector 170 mounted in the side frame 130. When the cutout 180 of the first end 150 engages the connector 170, the ground stake may be pivoted about a second pin or bolt connector 170 into position substantially aligned with the side frame 130, and fastened there by the connectors 170, which may be bolts or thumbscrews.

FIG. 6 shows an embodiment of the portable sign system 100 of FIG. 2, removed from ground mounting, with the ground stakes 140 in a second position, where the ground stakes 140 are connected to the respective frame sides 130 by the connectors 170, with the second ends 160 of the ground stakes 140 in an upright position, thus shortening the overall length of the portable sign system 100 for easy transport, as previously discussed.

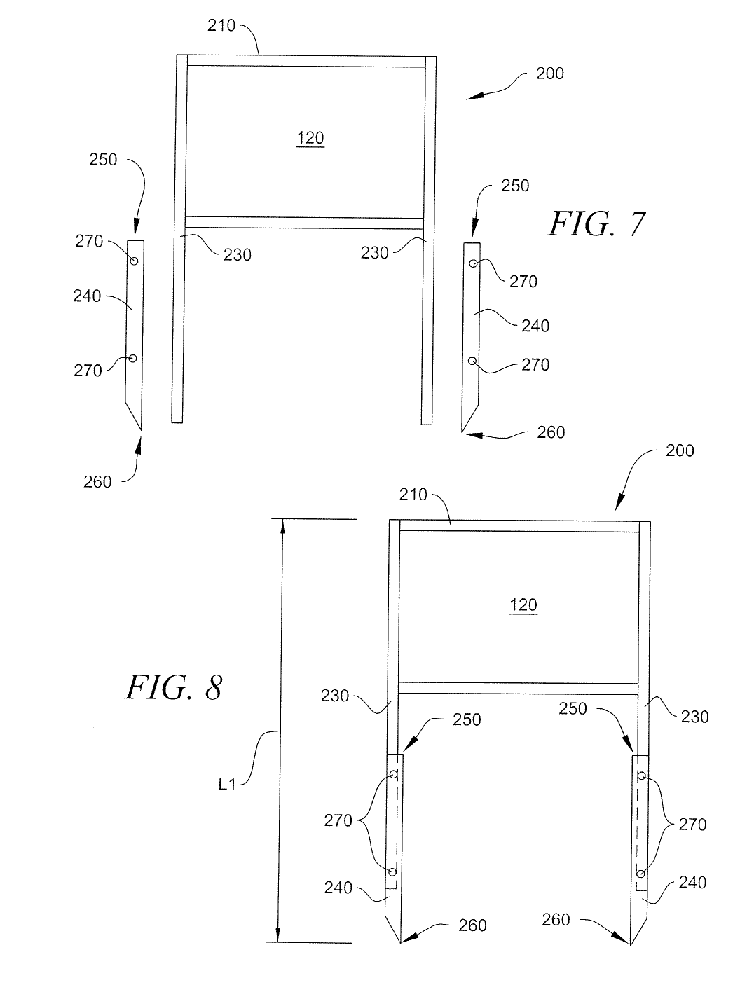

FIGS. 7-9 show a further embodiment of the portable sign system 200, where the display frame 210 has legs 230. A display frame 210 component is capable of holding a typical flat display placard 220, such as a real-estate “For Sale” sign. Again, the display frame 210 is preferably rectangular, but may if convenient or desired be formed in some other shape, such as a square or a circle, in this embodiment.

Associated with each leg 230 is a ground stake 240. Each ground stake 240 has a first end 250 and a second end 260. The second end 260 of each ground stake 240 is preferably pointed for easier insertion into the ground, but need not be so made. Each ground stake 240 is capable of being attached to the corresponding leg 230 in two opposite positions.

Again, the display frame 210, legs 230, and ground stakes 240 may be conveniently made of steel in the structural shape known as “angle iron.” Other material, or with a different cross-sectional shape, could also be used, so long as it is rigid and strong enough to resist the forces applied to it.

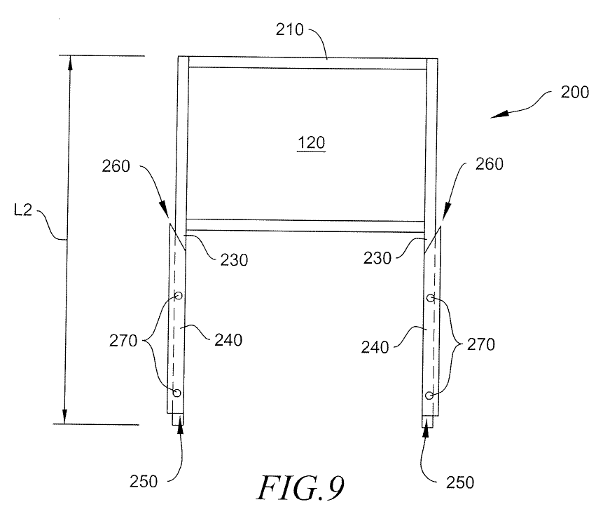

FIG. 8 shows the ground stakes 240 in this embodiment releaseably connected to the legs 230 in a first position where the second end 260 of each ground stake 240 is directed downwardly for insertion into the ground, and the first end 250 of the ground stake 240 is directed upward. The overall length of the sign 200 is called “L1” in FIG. 8.

The ground stakes 240 are releaseably connected to the legs 230 at one or more connectors 270, as shown in the figures. Again, the connectors 270 need only be strong enough to hold the legs 230 and stakes 240 together during insertion into the ground, and thereafter against wind forces or accidental bumps, and preferably are types easily undone and re-done. The connectors 270 can be, for example, bolts, screws, pins in holes or slotted openings, or pin-and-detent devices, all as are known in the art relating to connectors.

In the configuration shown in FIG. 8, the portable sign system 200 may be easily inserted into position, by forcing the ground stakes 240 into the ground, such as a residential yard, by applying pressure to the top of the display frame 210. When so inserted into the ground, the portable sign system 200 will be as sturdy as a cumbersome conventional sign frame.

FIG. 9 shows the portable sign system 200 removed from ground mounting, with the ground stakes 240 in a second position, where the ground stakes 240 are connected to the respective legs 230 by the connectors 270, with the second ends 260 of the ground stakes 240 in an upright position, thus shortening the overall length of the portable sign system 200 for easy transport. The overall length of the sign 200 is called “L2” in FIG. 9 L2 is less than L1 by a distance approximately equal to the lengths of the ground stakes 240, and so the sign 200 may be easily fitted into the trunk of an automobile. The length L2 can be easily estimated and provided for in the construction of the portable sign system 200 by consulting manufacturer's specifications for trunk dimensions of vehicles typically used by real-estate agents.

None of the description in this application should be read as implying that any particular element, step, or function is an essential element which must be included in the claim scope; the scope of patented subject matter is defined only by the allowed claims. Moreover, none of these claims are intended to invoke paragraph six of 35 U.S.C. Section 112 unless the exact words “means for” are used, followed by a gerund. The claims as filed are intended to be as comprehensive as possible, and no subject matter is intentionally relinquished, dedicated, or abandoned.

I claim:

1. A portable sign system; the portable sign system comprising:
a display frame;
the display frame having at least two frame sides;
at least two ground stakes;
each of the ground stakes capable of engaging one of the frame sides:
in a first position, where each of the ground stakes are extended from the respective frame side for inserting the ground stake into the earth; and,
in a reversed second position engaging a respective one of the frame sides, so that the overall length of the portable sign system when the ground stakes are in the second position is thereby less than in the first position; and,
at least one connector releaseably connecting each of the ground stakes to the respective frame side for movement between the first position and the second position.

2. The portable sign system of claim 1, where each of the ground stakes has a pointed end.

3. The portable sign system of claim 2, where in the first position of the ground stakes, the pointed ends of the ground stakes are directed downwardly for insertion into the ground.

4. The portable sign system of claim 1, where the frame sides and ground stakes are made of steel in the structural shape of angle iron.

5. The portable sign system of claim 1, where the at least one connector comprises a plurality of connectors.

6. The portable sign system of claim 1, where the at least one connector comprises a bolt and a threaded receiver for the bolt.

7. The portable sign system of claim 1, further comprising:
each ground stake having a first end and a second end;
the first end of each ground stake having a cutout;
the at least one connector comprising a bolt and a threaded receiver for the bolt; the bolt engaging the cutout in the first end of each ground stake when the respective ground stake is in the first position.

8. A portable sign system; the portable sign system comprising:
a display frame;
the display frame having at least two vertical frame sides and a bottom frame side;
at least two ground stakes;
each of the ground stakes capable of engaging one of the vertical frame sides in a first position, where the each of the ground stakes are extended from the respective vertical frame side for inserting the ground stake into the earth; and,
each of the ground stakes, when removed from engagement with the respective vertical frame side, capable of engaging the bottom frame side in a second position, so that the overall length of the portable sign system when the ground stakes are in the second position is thereby less than in the first position; and,
at least one first connector for releaseably connecting each of the ground stakes to the respective vertical frame side in the first position; and,
at least one second connector for releaseably connecting the ground stakes to the bottom frame side in the second position.

9. The portable sign system of claim 8, where each of the ground stakes has a pointed end.

10. The portable sign system of claim 9, where in the first position of the ground stakes, the pointed ends of the ground stakes are directed downwardly for insertion into the ground.

11. The portable sign system of claim 8, where the frame sides and ground stakes are made of steel in the structural shape of angle iron.

12. The portable sign system of claim 9, where the at least one connector comprises a plurality of first connectors.

13. The portable sign system of claim 8, where the at least one first connector comprises a bolt and a threaded receiver for the bolt.

14. The portable sign system of claim 8, further comprising:
each ground stake having a first end and a second end;
the first end of each ground stake having a cutout;
the at least one connector comprising a bolt and a threaded receiver for the bolt; the bolt engaging the cutout in the first end of each ground stake when the respective ground stake is in the first position.

15. A portable sign system; the portable sign system comprising:
a display frame;
the display frame having at least two support legs;
at least two ground stakes;
each of the ground stakes capable of engaging one of the support legs:
in a first position, where the ground stake is extended from the respective support leg for inserting the ground stake into the earth; and,
in a second position, so that the overall length of the portable sign system when the ground stakes are in the second position is thereby less than in the first position; and,
at least one connector releaseably connecting each of the ground stakes to the respective support legs for movement between the first position and the second position.

16. The portable sign system of claim 15, where each ground stake has a pointed end.

17. The portable sign system of claim 16, where in the first position of the ground stakes, the pointed ends of the ground stakes are directed downwardly for insertion into the ground.

18. The portable sign system of claim 15, where the support legs and ground stakes are made of steel in the structural shape of angle iron.

19. The portable sign system of claim 15, comprising a plurality of connectors.

20. The portable sign system of claim 15, where the at least one connector comprises a bolt and a threaded receiver for the bolt.
